(19) United States
(12) Patent Application Publication
(10) Pub. No.: US 2026/0081762 A1
(43) Pub. Date: Mar. 19, 2026

(54) Method for Implementing Fine-Grained Data Access and Sharing in 6G Networks Based on Fog Computing and Cloud Computing Environments

(71) Applicant: THE THIRD RESEARCH INSTITUTE OF MINISTRY OF PUBLIC SECURITY, Shangai (CN)

(72) Inventors: Bei PEI, Shanghai (CN); Yan ZHANG, Shanghai (CN); Ying ZHANG, Shanghai (CN); Jian GU, Shanghai (CN)

(21) Appl. No.: 19/109,382

(22) PCT Filed: Apr. 24, 2023
(86) PCT No.: PCT/CN2023/090177

§ 371 Date: Mar. 6, 2025

(30) Foreign Application Priority Data
Sep. 9, 2022 (CN) 202211101950.4
Oct. 21, 2022 (CN) 202211292322.9

(51) Int. Cl. H04L 9/08; H04W 12/041; H04W 12/0433

(52) U.S. Cl. CPC H04L 9/0825; H04L 9/0869; H04L 9/0891; H04W 12/041; H04W 12/0433

(57) ABSTRACT

A method for implementing fine-grained data access sharing in 6G network based on fog computing and cloud computing environment includes: (1) a security parameter is given for initialization; (2) each user is registered as a user with the said attribute authority AA; (3) a corresponding user private key is generated given a set of attributes S of a user; (4) an access policy is given by the owner of the data and data encryption is performed; (5) the user performs the data decryption process according to the embedded policy for the set of owned attributes in different environments; (6) the update key generation process is performed; (7) after receiving the private key update key from the attribute authority AA, the user updates the private key component associated with the revoked attribute in order to complete the private key update process; (8) upon receiving the ciphertext update key from the attribute authority AA, the cloud server updates the ciphertext component associated with the revocation attribute to complete the ciphertext update process.

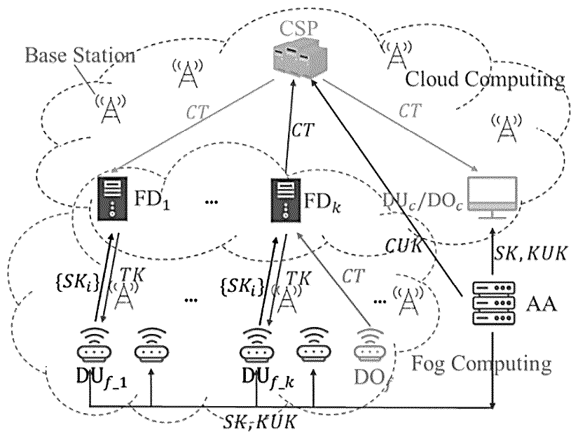

### CROSS-REFERENCE TO RELATED APPLICATION

This application claims priority of Chinese Invention patent application No. 202211101950.4 filed Sep. 9, 2022, and Chinese invention patent application No. 202211292322.9 filed on Oct. 21, 2022, the contents of which are incorporated herein by reference.

### FIELD OF TECHNOLOGY

The present invention relates to the field of fog computing and cloud computing technologies, and more particularly to the field of fine-grained data access control and sharing technologies, specifically, it refers to a method for implementing fine-grained data access control and sharing in 6G networks based on fog computing and cloud computing environments.

### DESCRIPTION OF RELATED ARTS

6G networks, as a multi-dimensional heterogeneous network integrating space, air, ground, and underground networks, include cloud computing and fog computing environments. In 6G networks, data security is a significant threat. To ensure data security and confidentiality, it is necessary to implement fine-grained data access control and resist quantum computing attacks.

Attribute-Based Encryption (ABE) is widely used in cloud computing and fog computing environments, enabling fine-grained data access control through attribute management. However, these algorithms are based on discrete logarithm problems or DH problems, making them vulnerable to quantum computing attacks. To address this, algorithms combining lattice-based encryption with ABE in cloud computing environments have emerged.

Attribute-Based Encryption (ABE) is a new type of identity-based encryption scheme, which can be divided into two categories: KP-ABE and CP-ABE. KP-ABE embeds the access policy in the user's key, allowing the user to search for ciphertexts that meet the attribute requirements. CP-ABE embeds the access policy in the ciphertext, ensuring that only users whose attributes meet the policy requirements can access the data.

CP-ABE ensures that users are flexibly divided into groups according to defined attributes, thereby ensuring secure data sharing, it is currently the most commonly used data storage algorithm in cloud and fog computing environments. The concept of attribute groups is introduced, dividing users into different groups based on their attribute sets. For dynamic user management, the attribute manager updates keys through a private key encryption key tree, enabling attribute revocation, so that the property can be revoked. Collusion attacks are common threats against attribute revocation.

Common lattice problems include SVP, CVP, and LWE, which are known for their resistance to quantum computing attacks. Therefore, encryption algorithms based on lattice problems have been proposed. However, these algorithms tend to have higher overhead compared to others. With the introduction of the GPV trapdoor function, its security has been proven, and it has been widely used in lattice-based encryption algorithms, significantly improving their efficiency.

Currently, there is no algorithm that is suitable for both cloud and fog computing environments, resistant to quantum computing attacks, and capable of fine-grained data access control. Developing a secure and efficient algorithm has become an urgent need.

Recent research has begun to combine CP-ABE with lattice-based encryption algorithms. However, these approaches have various issues, including vulnerability to certain security attacks, inability to implement attribute revocation, and inflexible policies. Moreover, they are not suitable for fog computing environments, as their efficiency would far exceed expectations.

### SUMMARY OF THE INVENTION

The objective of the present invention is to overcome the aforementioned shortcomings of the above-mentioned prior art, providing a method for achieving fine-grained data access and sharing in 6G networks under fog computing and cloud computing environments. This method is capable of formulating flexible access control policies, enabling secure attribute revocation, and resisting various security attacks.

To achieve the aforementioned objective, the method for realizing fine-grained data access and sharing in 6G networks under fog computing and cloud computing environments according to the present invention is as follows:

The method for implementing fine-grained data access and sharing in 6G networks based on fog computing and cloud computing environment is primarily characterized in that the method comprises the following steps:
(1) initializing an Attribute Authority (AA);
(2) registering each user with the Attribute Authority (AA);
(3) generating a user private key for each user's attribute set through the Attribute Authority (AA);
(4) A data owner providing an access policy (M, ρ), and encrypting data for attribute sets that meet the policy requirements;
(5) users decrypting data based on the embedded policy according to their attribute sets in different environments;
(6) the Attribute Authority (AA) performing key update processing with the cloud server for users whose attributes have not been revoked;
(7) upon receiving the private key update key, users with unrevoked attributes completing the private key update;
(8) the cloud server completing the ciphertext update based on the received ciphertext updates key.

Preferably, the step (1) specifically comprises the following steps:
(1.1) generating a random master key value K₀ and a random value a, and obtaining a public key PK₀=ak₀+pe₀ through a small positive integer p and a small error value e₀;
(1.2) given a set of attributes U, for each attribute u; E U, the Attribute Authority (AA) randomly selects a unique attribute key

$$( {K}_{i} , {K}_{i}^{- 1} ) ,$$

a unique version value

$$( {VK}_{i} , {VK}_{i}^{- 1} ) ,$$

and generates an attribute public key PKᵢ=VKᵢ·Kᵢ+peᵢ;
(1.3) finally, the Attribute Authority (AA) saves the master key

$$MSK = \{ {K}_{0} , {\{ {K}_{i} , {K}_{i}^{- 1} \}}_{i = 1}^{λ} \}$$

used to generate the public key, and publishes the public parameters

$$PP = \{ a , {PK}_{0} , {\{ {PK}_{i} \}}_{i = 1}^{λ} \}$$

including the public key, thereby achieving fine-grained data access and sharing through attribute management.

Preferably, before step (1.1), the method further comprises:
given a security parameter κ, the Attribute Authority (AA) selects a prime modulus q=1 mod 2κ and a small positive integer p, ensuring that p<<q and that they are coprime;
the Attribute Authority (AA) selects an integer n that is a power of 2, obtains an integer polynomial f(x)=xⁿ+1∈Z[x], and accordingly obtains a ring R_{q}=Z_{q}[x]/f(x) with f(x) and q as the integer polynomial modulus, where Zₙ[x] is the integer ring with modulus q, and xⁿ is the n-th power of x.

Preferably, the step (2) specifically comprises:
each user registers with the Attribute Authority (AA), and if the identity is legitimate, the Attribute Authority (AA) assigns a global identity value uid and a dedicated key generation value (t, t⁻¹) to the user, which are kept secret.

Preferably, the step (3) specifically comprises the following steps:
(3.1) given a user's attribute set S as a subset of attributes U, selecting an error value

$${e}_{i}^{′}$$

for each attribute uᵢ, a common error value e′, and a common hash function H(⋅);
(3.2) the Attribute Authority (AA) calculates SK₀=K₀·t⁻¹. H(uid)⁻¹+pe′, and an attribute private key component

$${SK}_{i} = {VK}_{i}^{- 1} \cdot {K}_{i}^{- 1} \cdot t \cdot H ( uid ) + {pe}_{i}^{′} ,$$

generating a user private key SK={SK₀,{SKᵢ}ᵤ_{ᵢ}_{∈S}}, where SK₀ is a component of the user private key that is independent of attributes.

Preferably, the step (4) specifically comprises the following steps:
(4.1) the data owner provides an access policy (M, ρ), ensuring that for the attribute set I∈{1, 2, . . . , l} that meets the policy requirements, the secret value δᵢ corresponding to attribute i can be obtained constant {ωᵢ}_{i∈I}, and based on the secret value δᵢ and constant {ωᵢ}, a shared value s=Σ_{i∈I}ωᵢδᵢ is calculated;
(4.2) the data owner selects a value r and error values e′,

$${e}_{i}^{′} ,$$

for the plaintext data m to be shared, generating a ciphertext

$$CT = \{ {C}_{0} , {\{ {C}_{i} \}}_{i = 1}^{l} \} ,$$

where C₀=PK₀·r·s+m+pe′,

$${C}_{i} = a \cdot {PK}_{i} \cdot r \cdot {δ}_{i} + {pe}_{i}^{′} ;$$

(4.3) if the data owner is a fog environment data owner DO_{f}, the ciphertext CT is sent to the fog node before being sent to the cloud server CSP; if the data owner is a cloud environment data owner DO_{c}, the ciphertext CT is directly sent to the cloud server CSP.

Preferably, the step (5) specifically comprises the following steps:
(5.1) for a fog environment user DU_{f}, if the attribute set A they possess satisfies the policy embedded in the ciphertext CT, the private key components {SKᵢ} are sent to the corresponding fog node, obtaining a decryption credential TK, and the corresponding fog node receives the private key components {SKᵢ} from the user and the ciphertext {Cᵢ} from the cloud server CSP, calculates the decryption credential TK=Σ_{i∈I}CᵢωᵢSKᵢ, and returns it to the user;
(5.2) the user calculates the data m=(C₀−SK₀·TK) modp through the decryption credential TK, completing the decryption of the ciphertext CT;
(5.3) for a cloud environment user DU_{c}, the user calculates the data m=(C₀-SK₀·Σ_{i∈I}CᵢωᵢSKᵢ) modp, thereby completing the decryption of the ciphertext CT.

Preferably, for the fog environment user DU_{f} and the cloud environment user DU_{c}:
if the attribute set A they possess satisfies the policy embedded in the ciphertext CT, then for I∈{1, 2, . . . , l} defined as I={i:ρ(i)∈A}, the user can obtain a set of constants {ωᵢ∈R_{q}}_{i∈I} from M, such that s=Σ_{i∈I}ωᵢδᵢ.

Preferably, step (6) specifically comprises the following steps:
(6.1) assuming the Attribute Authority (AA) revokes an attribute u_{μ}, the Attribute Authority (AA) generates a new version number

$${VK}_{μ}^{′}$$

for this attribute, and obtains a private key update key

$${KUK}_{μ} = {K}_{μ}^{- 1} \cdot t \cdot H ( uid ) \cdot ( {( {VK}_{μ}^{′} )}^{- 1} - {VK}_{μ}^{- 1} )$$

and a ciphertext update key

$${CUK}_{μ} = a \cdot r \cdot {δ}_{μ} \cdot {K}_{i} ( {VK}_{μ}^{′} - {VK}_{μ} ) ;$$

(6.2) the Attribute Authority (AA) sends the private key update key to the user and sends the ciphertext update key to users who have not revoked this attribute and the cloud server CSP.

Preferably, step (7) specifically comprises:
upon receiving the private key update key from the Attribute Authority (AA), each user whose permission for attribute u_{μ} has not been revoked updates the corresponding attribute private key component with

$${SK}_{μ}^{′} = {KUK}_{μ} + {SK}_{μ} ,$$

obtaining the updated user private key

$$\{ {SK}_{0} , {\{ {SK}_{i} \}}_{{u}_{i} ∈ S , i \neq μ} , {SK}_{μ}^{′} \} ,$$

where SK_{μ} is the private key component corresponding to attribute u_{μ}.

Preferably, step (8) specifically comprises:
upon receiving the ciphertext update key from the Attribute Authority (AA), the cloud server CSP updates the ciphertext component associated with the revoked attribute u_{μ} to

$${C}_{μ}^{′} = {C}_{μ} + {CUK}_{μ} ,$$

finally obtaining the updated ciphertext

$${CT}^{′} = \{ {C}_{0} , {\{ {C}_{i} \}}_{i = 1 , i \neq μ}^{l} , {C}_{μ}^{′} \} ,$$

where C_{μ} is the ciphertext component associated with the revoked attribute u_{μ}.

This method of the present invention for implementing fine-grained data access sharing in 6G networks based on fog computing and cloud computing environments is adopted to ensure secure data sharing and fine-grained access control in cloud computing and fog computing environments, and a new CP-ABE structure is constructed through the designed fog nodes, which include two different kinds of data owners and data users, the data owner is able to decrypt the ciphertext if its attribute set satisfies the access policy embedded in the ciphertext. The present technical solution can effectively resist quantum computing attacks and ensure the security of data sharing in IoT devices and traditional cloud computing devices, and based on the R-LWE challenge, an effective anti-quantum computing attack algorithm is designed and it is merged with the CP-ABE algorithm. In addition, this technical solution reduces the complex computational overhead of IoT devices by fog nodes, which calculate the decryption credentials provided to IoT devices.

It also enables secure attribute revocation against conspiracy attacks. By proposing a secure and efficient attribute revocation scheme for CP-ABE, attribute revocation is accomplished by updating only the components related to the assigned revocation attributes, ensuring that only users whose attribute sets conform to the attribute policy are able to decrypt the ciphertext. The scheme prevents illegal users from illegally decrypting the ciphertext through conspiracy by embedding the user's identity information component into the user key. Meanwhile, the scheme formally proves its security against various attacks through RLWE and BDD puzzles.

### BRIEF DESCRIPTION OF THE DRAWINGS

The FIGURE shows an overall flowchart of the method of the present invention for implementing fine-grained data access and sharing in 6G network based on fog computing and cloud computing environments.

### DETAILED DESCRIPTION OF THE PREFERRED EMBODIMENT

In order to be able to understand the technical content of the present invention more clearly, is further exemplified by the following detailed description of embodiments.

Before describing in detail the embodiments according to the present invention, it should be noted that, in the following, the terms “including”, “comprising” or any other variant are intended to cover non-exclusive inclusion, so that a processes, methods, goods, or equipment comprising a set of elements contains more than just those elements, and it also contains other elements that are not explicitly listed or that are inherent to such processes, methods, goods, or equipment.

Referring to the FIGURE, the method for implementing fine-grained data access sharing in 6G network based on a fog computing and cloud computing environment, wherein said method comprises the following steps:
(1) initializing an Attribute Authority (AA);
(2) registering each user with the Attribute Authority (AA);
(3) generating a user private key for each user's attribute set through the Attribute Authority (AA);
(4) A data owner providing an access policy (M, ρ), and encrypting data for attribute sets that meet the policy requirements;
(5) users decrypting data based on the embedded policy according to their attribute sets in different environments;
(6) the Attribute Authority (AA) performing key update processing with the cloud server for users whose attributes have not been revoked;
(7) upon receiving the private key update key, users with unrevoked attributes completing the private key update;
(8) the cloud server completing the ciphertext update based on the received ciphertext updates key.

As a preferred embodiment of the present invention, the step (1) specifically comprises the following steps:
(1.1) given a security parameter κ, and a set of attributes U={u₁, u₂, . . . , u_{λ}}, the Attribute Authority (AA) selects a sufficiently large prime modulus q=1 mod 2κ and a small positive integer p, ensuring that p<<q and that they are coprime;
(1.2) the Attribute Authority (AA) selects an integer n that is a power of 2, obtains f(x)=xⁿ+1 ∈Z[x], and accordingly obtains a ring R_{q}=Z_{q}[x]/f(x) with f(x) and q as the integer polynomial modulus, where Z_{q}[x] is the integer ring with modulus q;
(1.3) according to a ring R_{q} discrete distribution of errors χ, a unique random master key K₀∂R_{q}, a random value a←R_{q}, a small error value₀←χ, obtaining a public key PK₀=ak₀+pe₀∈R_{q};
(1.4) for each attribute uᵢ∈U, the Attribute Authority (AA) randomly selects a unique attribute key

$$( {K}_{i} , {K}_{i}^{- 1} ) ← {R}_{q} ,$$

a unique version value

$$( {VK}_{i} , {VK}_{i}^{- 1} ) ← {Z}_{q} ,$$

and obtain an attribute public key PKᵢ=VKᵢ·Kᵢ+peᵢ∈R_{q};
(1.5) finally, the Attribute Authority (AA) saves the master key

$$MSK = \{ {K}_{0} , {\{ {K}_{i} , {K}_{i}^{- 1} \}}_{i = 1}^{λ} \} ,$$

and publishes the public parameters

$$PP = \{ a , {PK}_{0} , {\{ {PK}_{i} \}}_{i = 1}^{λ} \} ,$$

thereby achieving fine-grained data access and sharing through attribute management.

As a preferred embodiment of the present invention, the step (2) specifically comprises:
each user completes registration with said attribute authority AA, and if the identity is legitimate, said attribute authority AA assigns a unique global identity value uid∈Z_{q} and randomly generates an exclusive key generation value (t, t⁻¹)∈(R_{q}×R_{q}) for the user for secret storage.

As a preferred embodiment of the present invention, the step (3) specifically comprises the following steps:
(3.1) given a user's attribute set S as a subset of attributes U, randomly choose unique value e′,

$${e}_{i}^{′} ← χ$$

for all attribute uᵢ in it, and map x∈Z_{q} to H(x)∈R_{q} according to the hash function H(⋅);
(3.2) the Attribute Authority (AA) calculates SK₀=K₀·t⁻¹. H(uid)⁻¹+pe′∈R_{q}, and an attribute private key component

$${SK}_{i} = {VK}_{i}^{- 1} \cdot {K}_{i}^{- 1} \cdot t \cdot H ( uid ) + {pe}_{i}^{′} ∈ {R}_{q} ( i \vert {u}_{i} ∈ S ) ,$$

generating a user private key SK={SK₀,{SKᵢ}ᵤ_{ᵢ}_{∈S}}, where SK₀ is a component of the user private key that is independent of attributes.

As a preferred embodiment of the present invention, the step (4) specifically comprises the following steps:
(4.1) the data owner provides an access policy (M, ρ), where

$$M ∈ {R}_{q}^{l \times θ} ,$$

each row i is labelled I={i:ρ(i)∈U} and a set of constants {wᵢ∈R_{q}}_{i∈I} can be obtained in M in polynomial time, enables shared values s=Σ_{i∈I}ωᵢδᵢ to be obtained for confidential values δᵢ corresponding to sets of attributes that meet policy requirements;
(4.2) based on the value s∈R_{q} obtained above, r₂, . . . , r_{θ}∈R_{q} are randomly chosen to form the vector \vec{v}=(s, r₂, . . . , r_{θ}), and for i taking values in the range from 1 to l, the user computes δᵢ=Mᵢ\vec{v}∈R_{q}, where Mᵢ is the ith row of M;
(4.3) the said data owner treats the data m∈R_{q} as a vector of coefficients of a polynomial m(x)=m₀+m₁x+ . . . +mₙ₋₁xⁿ⁻¹, where ∀j∈[n], mⱼ∈{0,1};
(4.4) the said data owner chooses an r←R_{q}, and an error value e′,

$${e}_{i}^{′} ← χ ,$$

and writes the ciphertext CT as

$$CT = \{ {C}_{0} , {\{ {C}_{i} \}}_{i = 1}^{l} \} ,$$

where C₀=PK₀·r·s+m+pe′∈R_{q},

$${C}_{i} = a \cdot {PK}_{i} \cdot r \cdot {δ}_{i} + {pe}_{i}^{′} ∈ {R}_{q} ;$$

(4.5) if the data owner is a fog environment data owner DO_{f}, the ciphertext CT is sent to the fog node before being sent to the cloud server CSP; if the data owner is a cloud environment data owner DO_{c}, the ciphertext CT is directly sent to the cloud server CSP.

As a preferred embodiment of the present invention, the step (5) specifically comprises the following steps:
(5.1) for user, if the attribute set A they possess satisfies the policy embedded in the ciphertext CT, it is defined as I∈{1, 2, . . . , l} of I={i:ρ(i)∈A}, the user is able to obtain a set of constants {ωᵢ ∈R_{q}}_{i∈I} from M, such that s=Σ_{i∈I} ωᵢδᵢ;
(5.2) for a fog environment user DU_{f}, the user sends the private key component {SKᵢ} to the corresponding fog node, obtaining a decryption credential TK, and the corresponding fog node receives the {SKᵢ} from the user, and receives the {Cᵢ} from the cloud server CSP, calculates TK=Σ_{i∈I} CᵢωᵢSKᵢ, and returns it to the user;
(5.3) the user completes the decryption process for the cloud server CT by calculating m=(C₀−SK₀·TK) modp;
(5.4) for a cloud environment user DU_{c}, the user calculates the data m=(C₀−SK₀·Σ_{i∈I}CᵢωᵢSKᵢ) modp, thereby completing the decryption of the CT.

As a preferred embodiment of the present invention, the step (6) specifically comprises the following steps:

(6.1) assuming the Attribute Authority (AA) revokes an attribute u_{μ}, the said Attribute Authority (AA) generates a new version number.

$${VK}_{μ}^{′}$$

for this attribute, then computes the user's private key update key

$${KUK}_{μ} = {K}_{μ}^{- 1} t H ( uid ) \cdot ( {( {VK}_{μ}^{′} )}^{- 1} - {VK}_{μ}^{- 1} )$$

and a ciphertext update key

$${CUK}_{μ} = a \cdot r \cdot {δ}_{μ} \cdot {K}_{i} ( {VK}_{μ}^{′} - {VK}_{μ} ) ;$$

(6.2) the Attribute Authority (AA) sends the private key update key to the user and sends the ciphertext update key to users who have not revoked this attribute and the cloud server CSP.

As a preferred embodiment of the present invention, the step (7) specifically comprises:
upon receiving the private key update key from the Attribute Authority (AA), each user whose permission for attribute u_{μ} has not been revoked updates the corresponding attribute private key component with

$${SK}_{μ}^{′} = {KUK}_{μ} + {SK}_{μ} ,$$

obtaining the updated user private key

$$\{ {SK}_{0} , {\{ {SK}_{i} \}}_{{u}_{i} ∈ S , i \neq μ} , {SK}_{μ}^{′} \} .$$

As a preferred embodiment of the present invention, the step (8) specifically comprises:
upon receiving the ciphertext update key from the Attribute Authority (AA), the cloud server CSP updates the ciphertext component associated with the revoked attribute u_{μ} to

$${C}_{μ}^{′} + {C}_{μ} + {CUK}_{μ} ,$$

finally obtaining the updated ciphertext

$${CT}^{′} = \{ {C}_{0} , {\{ {C}_{i} \}}_{i = 1 , i \neq μ}^{l} , {C}_{μ}^{′} \} ,$$

where C_{μ} is the ciphertext component corresponding to attribute u_{μ}.

In the practical application, this technical solution of this fog computing and cloud computing environment 6G network to achieve fine-grained data access sharing will be implemented in accordance with the following algorithmic principles:
1. AA (Attribute Authority) initialization: given a security parameter κ, and a set of attributes U={u₁, u₂, . . . , u_{λ}}, AA chooses a sufficiently large prime modulus q=1 mod 2κ and a small positive integer p, ensuring that p<<q and that they are coprime; AA selects an integer n that is a power of 2, obtains f(x)=xⁿ+1 ∈Z[x], and accordingly obtains a ring R_{q}=Z_{q}[x]/f(x) with simultaneously f(x) and q as the integer polynomial modulus, where Z_{q}[x] is the integer ring with modulus q, an error distribution χ according to the discrete distribution R_{q}, a unique random master key value K₀←R_{q}, a random value a←R_{q}, a small error value₀←χ, obtaining a public key PK₀=ak₀+pe₀∈R_{q}. For each attribute uᵢ∈U, AA randomly selects a unique attribute key

$$( {K}_{i} , {K}_{i}^{- 1} ) ← {R}_{q} ,$$

a unique version value

$$( {VK}_{i} , {VK}_{i}^{- 1} ) ← {Z}_{q} ,$$

and obtained an attribute public key PKᵢ=VKᵢ·Kᵢ+peᵢ∈R_{q}. Finally, AA saves the master key

$$MSK = [ {K}_{0} , {\{ {K}_{i} , {K}_{i}^{- 1} \}}_{i = 1}^{λ} \} ,$$

publishes the public parameters.

$$PP = \{ a , {PK}_{0} , {\{ {PK}_{i} \}}_{i = 1}^{λ} \} ,$$

thereby achieving fine-grained data access and sharing through attribute management.
2. User registration: each user completes their registration with AA. If the identity is legitimate, AA assigns a unique global identity value uid∈Z_{q} and generates a random (t, t⁻¹)∈(R_{q}× R_{q}) secret for the user to keep.
3. Private key generation: given a user's attribute set S as a subset of U, randomly select unique error values e′,

$${e}_{i}^{′} ← χ$$

for all uᵢ∈S in it, and according to the hash function H(⋅) that maps H(x)∈R_{q} to x∈Z_{q}. Then AA calculates SK₀=K₀·t⁻¹·H(uid)⁻¹+pe′∈R_{q},

$${SK}_{i} = {VK}_{i}^{- 1} \cdot {K}_{i}^{- 1} \cdot t \cdot H ( uid ) + {pe}_{i}^{′} ∈ {R}_{q} ( i \vert {u}_{i} ∈ S ) ,$$

generating a user private key SK={SK₀,{SKᵢ}ᵤ_{ᵢ}_{∈S}}.
4. Data encryption: data owner provides an access policy (M, ρ), where

$$M ∈ {R}_{q}^{l \times θ} ,$$

each row i is labelled I={i:ρ(i)∈U} and a set of constants {wᵢ∈R_{q}}_{i∈I} can be obtained in M in polynomial time, enables shared values s=Σ_{i∈I}ωᵢδᵢ to be obtained for confidential values δᵢ corresponding to sets of attributes that meet policy requirements. Based on the s∈R_{q}, r₂, . . . , r_{θ}∈R_{q} are randomly chosen to form the vector \vec{v}=(s, r₂, . . . , r_{θ}). And for i taking values in the range from 1 to l, the user computes δᵢ=Mᵢ\vec{v}∈R_{q}, where Mᵢ is the ith row of M. The data owner treats the data m∈R_{q} as a vector of coefficients of a polynomial m(x)=m₀+m₁x+ . . . +mₙ₋₁xⁿ⁻¹, where ∀j∈[n], mⱼ∈{0,1}. Then, the data owner chooses an r←R_{q}, and an error value e′,

$${e}_{i}^{′} ← χ ,$$

and writes the ciphertext CT as

$$CT = \{ {C}_{0} , {\{ {C}_{i} \}}_{i = 1}^{l} \} ,$$

where C₀=PK₀·r·s+m+pe′∈R_{q},

$${C}_{i} = a \cdot {PK}_{i} \cdot r \cdot {δ}_{i} + {pe}_{i}^{′} ∈ {R}_{q} .$$

If the data owner is DO_{f} (data owner in fog environment), the CT will be sent to the fog node before sending to the CSP (cloud server); if the data owner is DO_{c} (data owner in cloud environment), the CT will be sent directly to the CSP.
5. Data decryption: for DU_{f} (users in fog environments), if the attribute set A they possess satisfies the policy embedded in the ciphertext CT, it is defined as I∈{1, 2, . . . , l} of I={i:ρ(i)∈A}, the user is able to obtain a set of constants {ωᵢ ∈R_{q}}_{i∈I} from M, such that s=Σ_{i∈I}ωᵢδᵢ. Then the user sends the private key component {SKᵢ} to the corresponding fog node, obtaining a decryption credential TK. And the corresponding fog node receives the {SKᵢ} from the user, and receives the {Cᵢ} from t CSP, calculates TK=Σ_{i∈I}CᵢωᵢSKᵢ, and returns it to the user. Finally, the user completes the decryption process for the CT by calculating m=(C₀−SK₀·TK) modp.

For DU_{c} (cloud environment user), if the set of owned attributes A satisfies the policy embedded in the ciphertext CT, then for I∈{1, 2, . . . , l} defined as I={i:ρ(i)∈A}, the user is able to obtain a set of constants {ωᵢ∈R_{q}}_{i∈I} from M, such that s=Σ_{i∈I}ωᵢδᵢ. Then, the user calculates the data m=(C₀−SK₀·Σ_{i∈I}CᵢωᵢSKᵢ) modp, thereby completing the decryption of the CT.
6. Update key generation: assuming AA revokes an attribute u_{μ}, the AA first generates a new version number

$${VK}_{μ}^{′}$$

for this attribute, then computes the user's private key update kay

$${KUK}_{μ} = {K}_{μ}^{- 1} \cdot t \cdot H ( uid ) \cdot ( {( {VK}_{μ}^{′} )}^{- 1} - {VK}_{μ}^{- 1} )$$

and a ciphertext update key

$${CUK}_{μ} = a \cdot r \cdot {δ}_{μ} \cdot {K}_{i} ( {VK}_{μ}^{′} - {VK}_{μ} ) ;$$

the AA sends the private key update key to the user and sends the ciphertext update key to users who have not revoked this attribute and CSP.
7. Private key update: upon receiving the private key update key from the AA, each user whose permission for attribute u_{μ} has not been revoked updates the corresponding attribute private key component with

$${SK}_{μ}^{′} = {KUK}_{μ} + {SK}_{μ} .$$

So obtaining the updated user private key

$$\{ {SK}_{0} , {\{ {SK}_{i} \}}_{{u}_{i} ∈ S , i \neq μ} , {SK}_{μ}^{′} \} .$$

8. Ciphertext Update: upon receiving the ciphertext update key from the AA, CSP updates the ciphertext component associated with the revoked attribute u_{μ} to

$${C}_{μ}^{′} = {C}_{μ} + {CUK}_{μ} ,$$

finally obtaining the updated ciphertext

$${CT}^{′} = \{ {C}_{0} , {\{ {C}_{i} \}}_{i = 1 , i \neq μ}^{l} , {C}_{μ}^{′} \} .$$

Referring to the FIGURE shows that DO i.e., Data Owner, which stores data in the cloud and shares it with the desired users. DO can be categorized into two types. Where, DO_{f} is an IoT device. Before storing data to CSP, it needs to access the target FD to be able to perform further services. The DO can be an intelligent device with moderate computational and storage resources. Unlike DO_{f}, DO_{c} does not need the help of FD to be able to provide data directly to CSP.

DU i.e., user, who tries to access the data stored in the cloud. DU can be categorized into two types. Among them, DU_{f} is an IoT device. After obtaining the data from CSP, it needs to get the decryption credentials from the target FD first. DU_{c} can be an intelligent device with moderate computing and storage resources. Unlike DU_{f}, DU_{c} can decrypt data directly from CSP without the help of FD.

CSP is a cloud server that stores encrypted data. It also provides ciphertext update service for attribute revocation.

FD is fog devices deployed at the edge of the network to provide various services. They store and transmit ciphertexts between DO_{f}, DU_{f} and CSP and provide decryption credentials for DU_{f}.

AA is the authority that manages and distributes keys for all users and is responsible for updating the ciphertext and user private key components.

In the specific implementation of the algorithm, taking into account the need to share data, the programme implementer first purchases or rents a server with sufficient space in a cloud environment. This server implements a sufficient number of functional interfaces by deploying the project and invokes them according to the needs of the programme implementer. These functions include: the ability to connect storage devices to store sufficient ciphertexts based on index information; inputting indexes to determine ciphertexts and performing simple calculations against other incoming information to make changes to the managed ciphertext components, i.e., acting as a CSP; and meeting the practical and reasonable business needs of other programme implementers.

In addition to the CSP, the programme implementer needs to provide sufficient AAs, which can be deployed as web pages, clients, apps supported by back-end projects, or physical registration windows that are offline to perform the relevant operations. The algorithmic implementation of the project deployed at the AA allows users to register through their own identification information, such as ID card, name, photo, phone number, etc. If registering online, AA needs to be able to confirm that the registrant is providing his or her own identification information by implementing facial recognition. After completing the registration AA needs to be able to connect to some official body to give verification of the legitimacy of this identity information. The unique identity values generated are stored in an encrypted manner on the local LAN or intranet environment, which needs to be strictly secured and accessed from both physical and service ports, which needs to be authorized and subject to strict auditing.

After completing the identity verification, AA will give matching attributes based on the user's identity, or may allow the administrator to manually assign them based on actual business requirements, and store the effective time of each attribute in the connected database, combined with the unique identity value obtained, which is expressed by means of a private key. This private key can be distributed to the user in the form of a Ukey, or stored as an electronic credential on the user's client or APP, or downloaded as an unmodifiable file and uploaded when decrypted. The public key and other public parameters can be disclosed in plaintext. When decrypting the ciphertext, the user can automatically obtain and substitute it in the background without additional steps.

In addition, the programme implementer also buys or rents enough fog nodes FD to complete the deployment of the backend project code, which is intended to connect with the web side, client side or APP at the DO_{f} as a relay to achieve the backend algorithm operation.

In order to achieve data encryption, after the data owner sets the attribute policy, the attribute policy is customized as a matrix M from the help of a web page, client or app and subsequently the data to be encrypted is uploaded. In the backend encryption process, the algorithm first reads the data into byte stream and transforms it into plaintext m through the project function implemented in the webpage, client or APP, completes the encryption of m into CT locally by obtaining the public parameter PP from the AA, and uploads the CT together with the attribute policy M to the CSP. The confidential data required for generating ciphertext is always kept locally and destroyed immediately after CT upload, with no possibility of leakage. All computation processes are done in the background, and the data owner only needs to make his/her own choice of attribute policy and then upload the plaintext data to be encrypted.

If the owner of the data is DO_{f}, during the data encryption process, the transmitted data need to use the fog node as the transit node with the CSP; if the owner of the data is DO_{c}, the data is directly sent to the CSP.

Each user who tries to get the ciphertext from the CSP sends his private key to the CSP. The sending of the private key is done through APP, client or webpage. The private key transmission process chooses the form of encrypted transmission to ensure the security of the transmission process. For DU_{f}, the fog node DU completes the decryption after receiving the private key component through the deployed project encryption end, and downloads the user selected ciphertext directly from the CSP, calculates the TK and encrypts the transmission, and returns to the user with the ciphertext. After the user completes the decryption through the encrypted transmission end function of APP, client and webpage, the user can calculate the plaintext data through TK and local private key component. For DU_{c}, users can directly compute the plaintext data locally through the background programme after getting the ciphertext from CSP. Users only need to select the data they need to obtain, and download, decrypt and display the plaintext are all done through the background. The plaintext can only be displayed, and cannot be copied, screenshot or downloaded, and the user information watermark is added to the background of the displayed page through the webpage, client and APP to ensure that the data is not leaked as far as possible, or the source can be traced in case of leakage. Ensure that when the attributes possessed by the user exceed the validity period and no longer comply with the access policy, the user can no longer read the plaintext, i.e., the user can only read the plaintext data during the validity period of the set of attributes that comply with the policy.

When the attribute revocation is performed, i.e., when the users registered with AA scan the data attributes stored in the database by setting a timed task to detect and find that a certain attribute u_{μ} of some people has exceeded the validity time, then AA will read the relevant user identity and attribute information, calculate the private key update key KUK_{μ} to send to the user, and send the ciphertext update key CUK_{μ} to users and CSP who have not yet revoked the attribute.

If the user's private key component is saved on the APP or client, it automatically receives and completes the update in the networked environment. If the user's private key component is saved on Ukey or other files, the update is completed when uploading and decrypting, and deleted after the update. If the unrevoked user has not updated for a long time, multiple private key update keys KUK_{μ} will be merged into one by calculation in the background and always saved, waiting for the network to complete the one-time automatic update, to ensure that the user's private key is always valid as long as it is within the validity period, and the storage overhead does not increase because of time.

After CSP receives the ciphertext update key CUK_{μ} from AA, it can directly complete the update through computation. As for the user who has already downloaded the ciphertext, i.e., DU_{c}, the local data is protected by the APP or client, which automatically obtains the CUK_{μ} after networking and completes the ciphertext updating to ensure that after the attribute is withdrawn, the user who does not comply with the access policy can not continue to decrypt the ciphertext.

Any process or method description depicted in the flowchart or otherwise described herein may be understood to represent a module, fragment, or portion of code comprising one or more executable instructions for implementing the steps of a particular logical function or process, and that the scope of the preferred embodiments of the present invention includes additional implementations, which may be, in no particular order as shown or discussed, including performing functions in a substantially simultaneous manner or in reverse order, according to the functions involved, should be understood by those skilled in the art to which embodiments of the present invention belong.

It should be understood that various parts of the invention may be implemented with hardware, software, firmware, or combinations thereof. In the above embodiments, a plurality of steps or methods may be implemented with software or firmware stored in memory and executed by a suitable instruction execution device.

One of ordinary skill in the art can appreciate that all or some of the steps carried out to realize the method of the above embodiments can be accomplished by instructing the associated hardware by means of a program, which can be stored in a computer-readable storage medium that, when executed, comprises one of the steps of the method embodiments or a combination thereof.

The storage media mentioned above may be read-only memories, disks or CD, etc.

In the description of this specification, reference to the terms “an embodiment”, “some embodiments”, “example”, “specific example”, or “embodiment” means that a specific feature, structure, material, or characteristic described in conjunction with the embodiment or example is included in at least one embodiment or example of the present invention. In this specification, schematic representations of the above terms do not necessarily refer to the same embodiments or examples. Moreover, specific features, structures, materials, or characteristics described may be combined in any one or more embodiments or examples in a suitable manner.

Although embodiments of the present invention have been shown and described above, it is to be understood that the above embodiments are exemplary and are not to be construed as a limitation of the present invention, and that one of ordinary skill in the art may make changes, modifications, substitutions, and variations of the above embodiments within the scope of the present invention.

This method of the present invention for implementing fine-grained data access sharing in 6G networks based on fog computing and cloud computing environments is adopted to ensure secure data sharing and fine-grained access control in cloud computing and fog computing environments, and a new CP-ABE structure is constructed through the designed fog nodes, which include two different kinds of data owners and data users, the data owner is able to decrypt the ciphertext if its attribute set satisfies the access policy embedded in the ciphertext. The present technical solution can effectively resist quantum computing attacks and ensure the security of data sharing in IoT devices and traditional cloud computing devices, and based on the R-LWE challenge, an effective anti-quantum computing attack algorithm is designed and it is merged with the CP-ABE algorithm. In addition, this technical solution reduces the complex computational overhead of IoT devices by fog nodes, which calculate the decryption credentials provided to IoT devices.

It also enables secure attribute revocation against conspiracy attacks. By proposing a secure and efficient attribute revocation scheme for CP-ABE, attribute revocation is accomplished by updating only the components related to the assigned revocation attributes, ensuring that only users whose attribute sets conform to the attribute policy are able to decrypt the ciphertext. The scheme prevents illegal users from illegally decrypting the ciphertext through conspiracy by embedding the user's identity information component into the user key. Meanwhile, the scheme formally proves its security against various attacks through RLWE and BDD puzzles.

In this specification, the present invention has been described with the reference to its specific embodiments. However, it is obvious still may be made without departing from the spirit and scope of the present invention, various modifications and transformation. Accordingly, the specification and drawings should be considered as illustrative rather than restrictive.

1. A method for implementing fine-grained data access and sharing in 6G networks based on fog computing and cloud computing environment, comprising the following steps:
(1) initializing an Attribute Authority (AA);
(2) registering each user with the Attribute Authority (AA);
(3) generating a user private key for each user's attribute set through the Attribute Authority (AA);
(4) A data owner providing an access policy (M, ρ), and encrypting data for attribute sets that meet the policy requirements;
(5) users decrypting data based on the embedded policy according to their attribute sets in different environments;
(6) the Attribute Authority (AA) performing key update processing with the cloud server for users whose attributes have not been revoked;
(7) upon receiving the private key update key, users with unrevoked attributes completing the private key update;
(8) the cloud server completing the ciphertext update based on the received ciphertext updates key.

2. The method for implementing fine-grained data access and sharing in 6G networks based on fog computing and cloud computing environment according to claim 1, wherein the step (1) comprises the following steps:
(1.1) generating a random master key value K₀ and a random value a, and obtaining a public key PK₀=ak₀+pe₀ through a small positive integer p and a small error value e₀;
(1.2) given a set of attributes U, for each attribute uᵢ∈U, the Attribute Authority (AA) randomly selects a unique attribute key
$$( {K}_{i} , {K}_{i}^{- 1} ) ,$$
a unique version value
$$( {VK}_{i} , {VK}_{i}^{- 1} ) ,$$
and generates an attribute public key PKᵢ=VKᵢ·Kᵢ+peᵢ;
(1.3) finally, the Attribute Authority (AA) saves the master key
$$MSK = \{ {K}_{0} , {\{ {K}_{i} , {K}_{i}^{- 1} \}}_{i = 1}^{λ} \}$$
used to generate the public key, and publishes the public parameters
$$PP = \{ a , {PK}_{0} , {\{ {PK}_{i} \}}_{i = 1}^{λ} \}$$
including the public key, thereby achieving fine-grained data access and sharing through attribute management.

3. The method for implementing fine-grained data access and sharing in 6G networks based on fog computing and cloud computing environment according to claim 2, wherein before step (1.1), the method comprises:
given a security parameter κ, the Attribute Authority (AA) selects a prime modulus q=Imod 2κ and a small positive integer p, ensuring that p<<q and that they are coprime;
the Attribute Authority (AA) selects an integer n that is a power of 2, obtains an integer polynomial f(x)=xⁿ+1 ∈Z[x], and accordingly obtains a ring R_{q}=Z_{q}[x]/f(x) with f(x) and q as the integer polynomial modulus, where Z_{q}[x] is the integer ring with modulus q, and xⁿ is the n-th power of x.

4. The method for implementing fine-grained data access and sharing in 6G networks based on fog computing and cloud computing environment according to claim 3, wherein the step (2) comprises:
each user registers with the Attribute Authority (AA), and if the identity is legitimate, the Attribute Authority (AA) assigns a global identity value uid and a dedicated key generation value (t, t⁻¹) to the user, which are kept secret.

5. The method for implementing fine-grained data access and sharing in 6G networks based on fog computing and cloud computing environment according to claim 4, wherein the step (3) comprises the following steps:
(3.1) given a user's attribute set S as a subset of attributes U, selecting an error value
$${e}_{i}^{′}$$
for each attribute uᵢ, a common error value e′, and a common hash function H(⋅);
(3.2) the Attribute Authority (AA) calculates SK₀=K₀·t⁻¹·H(uid)⁻¹+pe′, and an attribute private key component
$${SK}_{i} = {VK}_{i}^{- 1} \cdot {K}_{i}^{- 1} \cdot t \cdot H ( uid ) + {pe}_{i}^{′} ,$$
generating a user private key SK={SK₀,{SKᵢ}ᵤ_{ᵢ}_{∈S}}, where SK₀ is a component of the user private key that is independent of attributes.

6. The method for implementing fine-grained data access and sharing in 6G networks based on fog computing and cloud computing environment according to claim 5, wherein the step (4) comprises the following steps:
(4.1) the data owner provides an access policy (M, ρ), where
$$M ∈ {R}_{q}^{l \times θ} ,$$
ensuring that for the attribute set I∈{1, 2, . . . , l} that meets the policy requirements, the secret value δᵢ corresponding to attribute i can be obtained constant {ωᵢ}_{i∈I}, and based on the secret value δᵢ and constant {ωᵢ}, a shared value s=Σ_{i∈I}ωᵢδᵢ is calculated;
(4.2) the data owner selects a value r and error values e′,
$${e}_{i}^{′} ,$$
shared, generating a ciphertext
$$CT = \{ {C}_{0} , {\{ {C}_{i} \}}_{i = 1}^{l} \} ,$$
C₀=PK₀·r·s+m+pe′,
$${C}_{i} = a \cdot {PK}_{i} \cdot r \cdot {δ}_{i} + {pe}_{i}^{′} ;$$
(4.3) if the data owner is a fog environment data owner DO_{f}, the ciphertext CT is sent to the fog node before being sent to the cloud server CSP; if the data owner is a cloud environment data owner DO_{c}, the ciphertext CT is directly sent to the cloud server CSP.

7. The method for implementing fine-grained data access and sharing in 6G networks based on fog computing and cloud computing environment according to claim 6, wherein the step (5) comprises the following steps:
(5.1) for a fog environment user DU_{f}, if the attribute set A they possess satisfies the policy embedded in the ciphertext CT, the private key components {SKᵢ} are sent to the corresponding fog node, obtaining a decryption credential TK, and the corresponding fog node receives the private key components {SKᵢ} from the user and the ciphertext {Cᵢ} from the cloud server CSP, calculates the decryption credential TK=Σ_{i∈I}CᵢωᵢSKᵢ, and returns it to the user;
(5.2) the user calculates the data m=(C₀−SK₀·TK) modp through the decryption credential TK, completing the decryption of the ciphertext CT;
(5.3) for a cloud environment user DU_{c}, the user calculates the data m=(C₀−SK₀·Σ_{i∈I}CᵢωᵢSKᵢ) modp, thereby completing the decryption of the ciphertext CT.

8. The method for implementing fine-grained data access and sharing in 6G networks based on fog computing and cloud computing environment according to claim 7, wherein for the fog environment user DU_{f} and the cloud environment user DU_{c}:
if the attribute set A they possess satisfies the policy embedded in the ciphertext CT, then for I∈{1, 2, . . . , l} defined as I={i:ρ(i)∈A}, the user can obtain a set of constants {wᵢ∈R_{q}}_{i∈I} from M, such that s=Σ_{i∈I} ωᵢδᵢ.

9. The method for implementing fine-grained data access and sharing in 6G networks based on fog computing and cloud computing environment according to claim 7, wherein step (6) comprises the following steps:
(6.1) assuming the Attribute Authority (AA) revokes an attribute u_{μ}, the Attribute Authority (AA) generates a new version number
$${VK}_{μ}^{′}$$
for this attribute, and obtains a private key update key
$${KUK}_{μ} = {K}_{μ}^{- 1} \cdot t \cdot H ( uid ) \cdot ( {( {VK}_{μ}^{′} )}^{- 1} - {VK}_{μ}^{- 1} )$$
and a ciphertext update key
$${CUK}_{μ} = a \cdot r \cdot {δ}_{μ} \cdot {K}_{i} ( {VK}_{μ}^{′} - {VK}_{μ} ) ,$$
where
$${K}_{μ}^{- 1}$$
is the attribute key for attribute u_{μ}, and VK_{μ} is the old version number for this attribute;
(6.2) the Attribute Authority (AA) sends the private key update key to the user and sends the ciphertext update key to users who have not revoked this attribute and the cloud server CSP.

10. The method for implementing fine-grained data access and sharing in 6G networks based on fog computing and cloud computing environment according to claim 9, wherein step (7) comprises:
upon receiving the private key update key from the Attribute Authority (AA), each user whose permission for attribute u_{μ} has not been revoked updates the corresponding attribute private key component with
$${SK}_{μ}^{′} = {KUK}_{μ} + {SK}_{μ} ,$$
obtaining the updated user private key
$$\{ {SK}_{0} , {\{ {SK}_{i} \}}_{{u}_{i} ∈ S , i \neq μ} , {SK}_{μ}^{′} \} ,$$
where SK_{μ} is the private key component corresponding to attribute u_{μ}.

11. The method for implementing fine-grained data access and sharing in 6G networks based on fog computing and cloud computing environment according to claim 10, wherein step (8) comprises:
upon receiving the ciphertext update key from the Attribute Authority (AA), the cloud server CSP updates the ciphertext component associated with the revoked attribute u_{μ} to
$${C}_{μ}^{′} = {C}_{μ} + {CUK}_{μ} ,$$
finally obtaining the updated ciphertext
$${CT}^{′} = \{ {C}_{0} , {\{ {C}_{i} \}}_{i = 1 , i \neq μ}^{l} , {C}_{μ}^{′} \} ,$$
where C_{μ} is the ciphertext component corresponding to attribute u_{μ}.
